(19) United States
(12) Patent Application Publication
(10) Pub. No.: US 2008/0257612 A1
(43) Pub. Date: Oct. 23, 2008

(54) Scale accessory

(75) Inventors: Samuel O. Raymond, Woods Hole, MA (US); Anker Berg-Sonne, Stow, MA (US); James T. Fearnside, Lexington, MA (US)

Correspondence Address: Edward L. Kelley;DBA Invention Management Associates, 5 Utica Street, Lexington, MA, 02420, US

(73) Assignee: Eternal Voyage Inc., Stow, MA (US)

(21) Appl. No.: 12/074,939

(22) Filed: Mar. 7, 2008

Related U.S. Application Data
(60) Provisional application No. 60/905,518, filed on Mar. 7, 2007.

(51) Int. Cl. G01G 21/22

(52) U.S. Cl. 177/253

(57) ABSTRACT

A scale accessory 102 includes a shelf 200 supported substantially coplanar with the weighing tray 150 of a scale 100. The shelf 200 extends a dimension of the weighing tray 150 and may be used to support a portion of the article to be weighed 550. A first portion 552 of the article to be weighed is supported on the weighing tray 150 and a second portion 554 of the article to be weighed is supported on the shelf 200 such that the weighing tray 150 only weighs the first portion 552. Proximate edges of the shelf 200 and the weighing tray 150 are separated by a slot 400 that forms a cutting or marking guide between the first portion 552 and the second portion 554. The scale accessory 102 allows a user to accurately weigh a portion of a large article such a fish or meat filet, mark a severing line 556 on the filet and then cut the filet along the severing line. The process allows the user to accurately divide the filet into a first portion 552 having a known weight and a remaining second portion 554 with an unknown weight.

### CROSS REFERENCE TO RELATED APPLICATIONS

This application claims the benefit of priority of U.S. Provisional Patent Application No. 60/905,518 by Raymond et al. entitled SCALE ACCESSORY FOR PRECISE CUTTING OF FLEXIBLE MATERIALS, filed on Mar. 7, 2007, which is incorporated herein by reference in its entirety.

### BACKGROUND OF THE INVENTION

1. Field of the Invention

The present invention provides a scale accessory for supporting a shelf coplanar with a weighing tray of a scale. In particular, an article to be weighed is partly supported on the weighing scale and partly supported on the shelf in order to weigh a portion of the article and cut the known weight portion from the article.

2. Description of the Related Art

Scales are used to weigh various articles in order to sell and article of a desired weight. A typical small application can be found in the retail food service industry where a customer may request a desired portion of a meat or fish filet, e.g. by specifying a weight, a total price or a percentage of the total filet. Often the desired portion is cut from a larger filet. Fillets usually are less than ten pounds total weight, are not frozen, and are under two inches thick. Therefore such a fillet is quite flexible. When a portion of a fillet having a desired weight is cut from the filet the place to cut the fillet is specified based upon judgment. After a cut is made, the desired portion is then weighed to determine its actual weight. Thereafter the desired portion is either trimmed or added to by cutting second portion from the larger filet to make up the desired weight. This is a time consuming and wasteful process. Often the needed portion is specified in different terms, either cost or a percentage of the total fillet weight. When the desired weight is specified in either percentage or cost terms, then calculations may need to be done to arrive at the required weight of the desired portion.

Table top digital scales are widely in the food service industry to weigh filets. Such digital scales are often operated to display both a weight and a price of an object supported on a scale weighing tray. Generally a price per unit weight conversion factor is stored in a memory of the scale or entered by a used. However the process of dividing a filet even when using a digital scale is still inefficient since the filet is often cut first then weighed and then cut again to adjust the weight as required.

Accordingly there is a need in the food service industry for an improved method for cutting a large filet in order to remove a portion of the filet having a more accurate desired weight. Moreover, the improved method must meet food industry product demands such as low equipment cost, made from food safe materials, easily cleaned and conforming to best food handling practices. Automatic handling equipment is usually an unjustified cost.

U.S. Pat. No. 226,083 to Noir and Chunn describes a balance scale having a movable platform for weighing an object and a fixed platform which may be extended to inclose the movable platform or place in close proximity to the movable platform. A pivotal cutting knife is placed at the junction of the two platforms. The device is used to cut a desired weight from a large article. One problem with the '083 patent is that the scale accessory items are permanently associated with a particular scale and are not easily adaptable to a variety of different scale configurations. Another problem is that as the movable platform is deflected by a weight, its coplanarity with the fixed platform changes and this induces measurement errors that are specifically addressed by the present invention.

U.S. Pat. No. 4,718,146 to Adkison, U.S. Pat. No. 4,868,951 to Akesson et al and U.S. Pat. No. 5,226,334 to Pegoraro teach special purpose machines that automatically cut a portion from a larger article where this portion is a predetermined weight. However all of these patents teach machines that are highly automated, with the article to be cut automatically positioned by the machine, not a human operator. These machines are expensive and therefore inappropriate for the retail food service industry. This invention depends upon a human operator to position the article to be cut in a manner where a portion of said article of a predefined weight may be separated from the remainder.

### SUMMARY OF THE INVENTION

The present invention overcomes the problems cited in the prior art by providing a scale accessory 102 for use with a scale 100. The scale 100 includes a bottom support surface opposed to a substantially horizontal top weighing tray 150. The weighing tray 150 supports an article to be weighed 550 thereon and the articles' weight is measured by the scale and displayed on a digital display 104. The scale is also programmable to display a price of the article based on the measured weight of the article and a desired price per unit weight stored in a scale memory or entered into the scale by a user on a key pad 106.

The scale accessory 102 includes a shelf 200 supported substantially coplanar with the weighing tray 150. The shelf 200 extends one or more dimensions of the weighing tray and may be used to support a portion of the article to be weighed 550 such that a first portion 552 of the article to be weighed is supported on the weighing tray 150 and a second portion 554 of the article to be weighed is supported on the shelf 200 such that the weighing tray 150 only weighs the first portion 552. The shelf 200 is positioned with respect to the weighing tray 150 such that a slot 400 between proximate edges of the shelf 200 and the weighing tray 150 forms a cutting or marking guide between the first portion 552 and the second portion 554. Accordingly the scale accessory 102 allows a user to accurately weigh a portion of a large article such a fish or meat filet, mark a severing line 556, defined by the slot 400, on the filet and then cut the filet along the severing line. The process allows the user to accurately divide the filet into a first portion 552 having a known weight and a remaining second portion 554 with an unknown weight. The article may be removed from the scale to make a final cut or cut in place on the scale.

The scale accessory 102 includes a base assembly 300 configured to horizontally support the scale bottom support surface thereon. A shelf bracket 310 is disposed between the base assembly 300 and the shelf 200 for fixedly attaching the shelf to the base assembly and the shelf bracket 310 is adjustable with respect to the base assembly 300 for adjusting the vertical height of the shelf in order to position the shelf 200 coplanar with the weighing tray 150. Preferably, all elements of the scale accessory 102 are fabricated from food safe materials such as stainless steel. The shelf may also comprise a cutting board material such as wood or plastic to allow cutting on the shelf surface. The slot 400 may also be adjusted to a wide enough width that a user can cut along the severing line 556 with a cutting tool passing through the slot 400.

### BRIEF DESCRIPTION OF THE DRAWINGS

The features of the present invention will best be understood from a detailed description of the invention and a preferred embodiment thereof selected for the purposes of illustration and shown in the accompanying drawings in which:

FIG. 1 is a perspective left sided view of a scale and scale accessory according to the present invention;

FIG. 2a is an exploded view of a scale accessory according to the present invention;

FIG. 2b is an exploded cutaway view depicting elements for supporting a removable shelf on a shelf bracket according to one aspect of the present invention;

FIG. 3 is a perspective top view of a scale and scale accessory operating to support an article to be weighed on a weighing tray of a scale and on a shelf of a scale accessory according to the present invention;

FIG. 4a is a front view depicting the effect of misalignment between a scale weighing tray and a shelf of a scale accessory according to the present invention;

FIG. 4b is a force diagram depicting forces on an article to be weighed caused by misalignment between a scale weighing tray and a shelf of a scale accessory according to the present invention; and,

FIG. 5 is a plot of article weight error as a function of vertical offset between a scale weighing tray and a shelf of a scale accessory according to the present invention.

### DESCRIPTION OF THE PREFERRED EMBODIMENTS

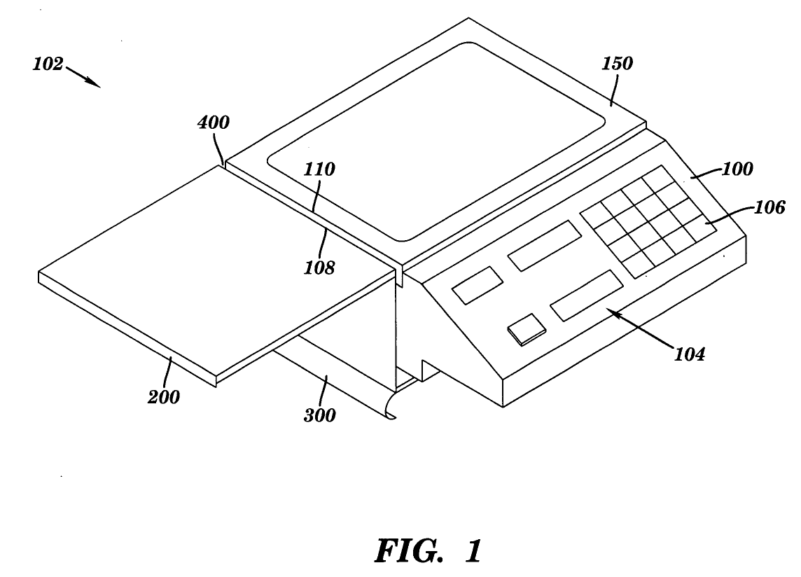

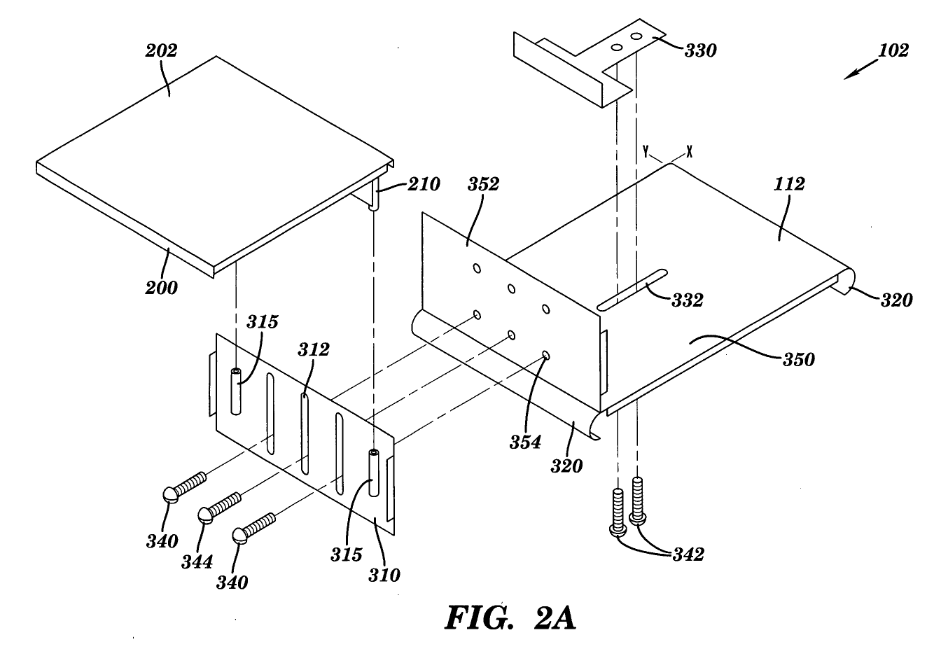

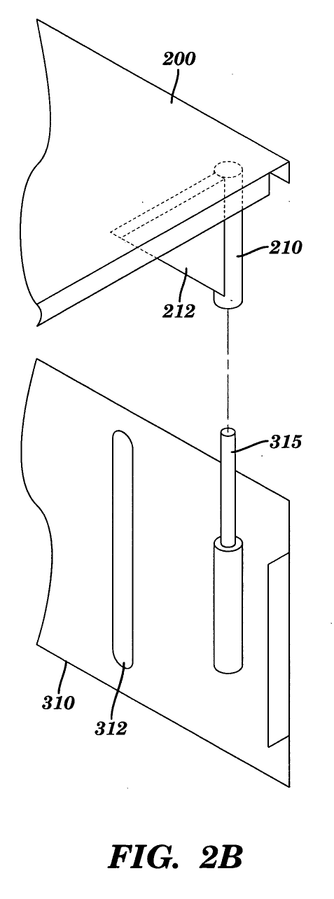

Referring to FIGS. 1 and 2a, a scale 100 used for weighing articles is shown supported on a scale accessory 102 according to the present invention. The scale accessory 102 comprises a removable shelf 200 attached to a left side of a base assembly 300. Preferably, the scale 100 is a table top scale configured with electronic weighing elements and digital processing elements capable of determining an article weight and displaying the article weight, and other data, on one or more digital display panels, generally indicated by reference numeral 104. In addition, the scale may include a key pad 106 usable to program or otherwise select various operating modes of the scale 100. One example scale 100 usable with the present invention is a Yousheng Engineering C-M model 101 manufactured by Shanghai Yousheng Weighing Apparatus Company of Shanghai China. However various other weighing devices are usable without deviating from the present invention.

The scale the 100 includes a bottom or base surface, not shown, used to support the scale on a substantially horizontal work surface, not shown, during operation. The scale 100 further includes a substantially planar top surface opposed to the base surface which functions as a weighing tray 150 which is preferably horizontally disposed at a vertical height above the work surface. Conventionally, the weighing tray 150 supports the entire weight of an article to be weighed and the scale 100 determines the article weight and displays the weight on a display device 104. In addition a user may enter a price per unit weight value using the scale key pad 106 and the scale may additionally or alternately display a sale price for the article in proportion to article weight. Additionally the scale may be programmable to display weights in different units of weight, e.g. pounds or kilograms, etc., and or prices in different currencies, e.g. dollars, euros, etc.

The scale accessory 102 further includes a shelf 200 attached to the base assembly 300 and cantilevered out there from to support the shelf 200 substantially coplanar with the weighing tray 150. In the example embodiment of the scale accessory 102, the shelf 200 extends a lateral dimension of the weighing tray 150 on the left side thereof. Alternately the scale accessory 102 is configurable to support the shelf 200 to extend a lateral dimension of the weighing tray 150 on the right side thereof or to extend a transverse dimension of the weighing tray 150 e.g. on a rear side thereof, opposed to the display devices 104 and key pad 106. In all cases, the shelf 200 is disposed substantially horizontally and substantially at the same vertical height above the work surface as the weighing tray 150.

The scale accessory 102 is configured to support the shelf 200 in a manner that forms a slot 400 between opposing peripheral edges of the weighing tray 150 and the shelf 200. In the example of FIG. 1, the slot 400 is formed between a right peripheral edge 108 of the shelf 200 and a left peripheral edge of the weighing tray 110. Preferably, the slot 400 has a uniform width to prevent contact between the shelf 200 and the weighing tray 150 along its length and the slot 400 provides a convenient cutting or making guide, which as will be detailed below, allows a user to cut or make an article being weighed.

Referring to FIGS. 2A and 2B, the scale accessory 102 is shown in exploded view with the scale 100 removed. The base assembly 300 includes a substantially horizontally disposed base plate 350 and a substantially vertically disposed shelf bracket support plate 352, attached to or integrally formed with the base plate 350. Two leg elements 320 attach to or are integrally formed with the base plate 350 to support the scale accessory on the work surface. Alternately, three or four leg elements 320 are usable without deviating from the present invention. In the present embodiment, the legs 320 support the scale accessory 102 sufficiently high above the work surface to stored the shelf 200 under base plate 350 when the shelf is not in use.

A top side 112 of the base plate 350 receives the bottom or base surface of the scale 100 thereon to horizontally support the scale on the base assembly 300. In the example embodiment, the base plate 350 is rectangular with lateral and transverse perimeter edge dimensions sized large enough to support the scale 100 on the base plate 350. However, other configurations of the base plate 350 are usable without deviating from the present invention.

The scale 100 is substantially centered on the base plate 350 along the transverse axis Y and the scale is forced against the shelf bracket support plate 352 along the lateral axis X and held in place by a scale securing bracket 330 which is adjustable to provide a clamping force along the lateral X axis. The scale securing bracket 330 attaches to the base plate 350 by screws 342, or other fasteners, and the securing bracket 330 is slotted to allow its lateral position to be adjustable with respect to the base plate 350 before the screws 342 fasten the scale securing bracket 330 into a fixed position. The scale securing bracket 330 is forced against one or more transverse surfaces of the scale 100, e.g. legs or edges of the scale 100, to secure the scale in a fixed position on the base plate 350. In addition, a scale lateral positioning screw 344 is installed through the vertical shelf bracket support plate 352 and through the shelf bracket 310 to contact a transverse surface of the scale 100 and to oppose the clamping force of the securing bracket 330. The scale lateral positioning screw 344 is usable to set an adjustable stop position for stopping the scale at a desired lateral position each time the scale is placed on the base plate 350. Moreover, the stop position determines a width of the slot 400 such that the scale lateral positioning screen 344 is usable to set the width of the slot 400 as may be required in various applications, e.g. a wider slot width may be used when the slot 400 is used as a cutting guide.

The vertically disposed shelf bracket support plate 352 comprises a rectangular plate extending substantially along a left transverse edge of the base plate 350 with a plurality of threaded or through holes 354 passing there through as required to attach to and support a shelf bracket 310. In the example embodiment, the shelf bracket support plate 352 extends along the full transverse length of the base plate 350 but other configurations are usable including two or more substantially verbally disposed bracket elements attached to the base plate 350.

A shelf bracket 310 is disposed between the shelf bracket support plate 352 and the shelf 200. In the example embodiment, the shelf bracket 310 is a rectangular plate formed with vertical slots 312 passing there through. The shelf bracket 310 attaches to the shelf bracket support plate 352 by fastening screws 340. The screws 340 pass through the vertical slots 312 and thread into threaded holes 354. The shelf 200 attaches to the shelf bracket 310 and is cantilevered there from. Adjustment of a vertical height of shelf 200 is accomplished by sliding shelf bracket 310 vertically against the shelf bracket support plate 352 until a desired vertical shelf height is achieved. Thereafter the fastening screws 340 are tightened to secure the shelf bracket 310 to the shelf bracket support plate 352. Preferably, the vertical height of the shelf 200 is adjusted with the scale 100 secured in place on the base plate 350 and the vertical height of the shelf 200 is adjusted to substantially match the vertical height of the weighing tray 150. In addition, the vertical slots 312 may be formed with enough clearance around the fastening screws 340 to slightly rotate the shelf 200 about an axis parallel to the lateral axis X in order to orient the shelf 200 to be substantially coplanar with the weighing tray 150.

Referring to FIG. 2B, two or more pin attaching elements 315, (only one is shown), are fixedly attached to shelf bracket 310 with a solid pin extending substantially vertically. The pin attaching elements 315 may be attached by welding, brazing, adhesive bonding, threaded fasteners or other attaching elements. The position and orientation of each pin attaching element 315 is controlled to mate with a corresponding hollow pin sockets 210 which is attached to an underside of shelf 200 by an integral bracket 212. The bracket 212 may be attached to the shelf 200 by welding, brazing, adhesive bonding, threaded fasteners or other attaching elements as required.

The shelf 200 is attached to the shelf bracket 310 by aligning hollow pin sockets 210 with corresponding pin attaching elements 315 and lowering the shelf 200 until the pin attaching elements 315 are fully engaged with the hollow pin sockets 210. Accordingly, a user can readily install and remove the shelf 200 from the scale accessory 102 by hand, without using tools and without removing any fasteners. This is a particularly important feature of the present invention especially when the scale 100 and scale accessory 102 are used for weighing food items since the shelf 200 may need to be removed for frequent cleaning and then replaced.

A suitable pin attaching element 315 and mating hollow pin socket 210 is a pin and socket hinge set part #1033-U1 available from EMKA Inc of Middletown Pa. U.S.A. The fit of the pins 315 into sockets 210 is selected to be sufficiently snug so that the shelf 200 is cantilevered from shelf bracket 310 without undue sagging which as will be described in detail below, cause weighing errors.

While the scale 100 and scale accessory 102 may be used for various applications, the scale accessory 102 is particularly useful for weighing and processing food items. Accordingly, the preferred embodiment of the scale accessory 102 is fabricated from materials that will not contaminate foods and that are easily cleaned. In particular, the above described elements of the scale accessory 102 is preferably fabricated from non-corrosive food safe metals or from metals that are coated with non-corrosive food safe coatings. In particular, stainless steel is a suitable metal. Alternately, some or all of the above described scale accessory elements may be fabricated from food safe plastics that are readily cleaned and resistant to damage from cleaning agents, food waste and other contaminants. In addition, the scale accessory 102 is designed for easy disassembly and reassembly to facilitate daily or more frequent cleaning.

In one example embodiment, the shelf 200 comprises stainless steel. However in another embodiment, the shelf 200 may be formed with its top surface 202 formed from a material that is appropriate for use as a cutting surface, e.g. for cutting food items positioned on the shelf top surface 202 with a knife. In particular, the shelf top surface 202 may comprise a high density polyethylene such as the material SANILITE® available from Qudrant Inc. of Reading Pennsylvania U.S.A.

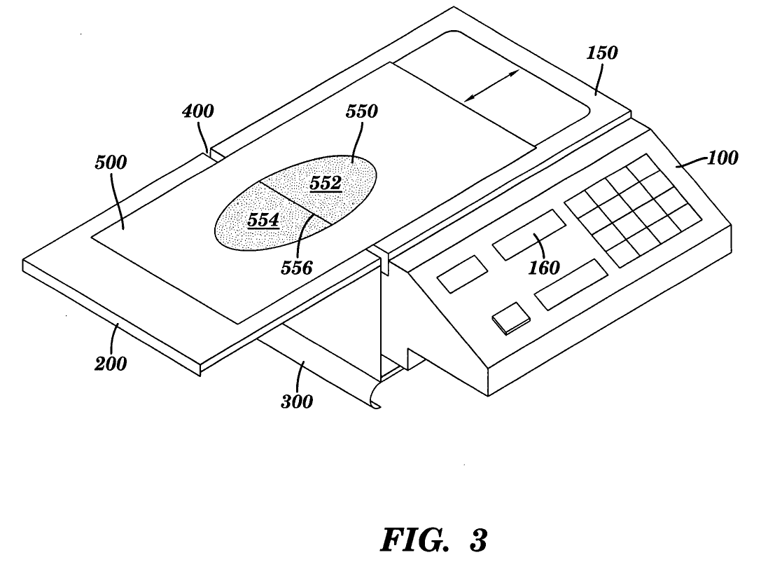

Referring now to FIG. 3, the scale 100 is shown mounted onto the scale accessory 102 and a unitary article 550 to be weighed is supported on both the shelf 200 and the weighing tray 150 such that the unitary article 550 startles the slot 400. Preferably, the unitary article 550 is a flexible article such as a fish or meat filet capable of some flexing movement, e.g. when the weighing tray 150 or shelf 200 are deflected by the weight of the unitary article 550. A membrane 500 such as “deli wrap,” may be placed under the unitary article 550 between the article to be weighed and the weighing tray and shelf to prevent contamination of the article and to keep the weighing tray and shelf clean. Accordingly, the weighing tray 150 supports a first portion 552 of the unitary article 550 and the shelf 200 supports a second portion 554 of the unitary article 550 and a boundary between the first portion 552 and the second portion 554 is approximately disposed along the slot 400. Moreover, the scale 100 weighs only the first portion 552 which is supported on the weighing tray 150.

Thus according to one aspect of the present invention, a user may use the scale 100 in combination with the scale accessory 102 to divide the unitary article 550 into two portions with the first portion 552 having a desired weight and a remaining second portion 554, which has an unknown weight. Alternately, the scale 100 is programmable to convert a weight of the first portion 552 into a price of the first portion using a price per unit weight conversion factor. Thus according to another aspect of the present invention, a user may use the scale 100 in combination with the scale accessory 102 to divide the unitary article 550 into two portions with the first portion 552 having a desired price and a remaining second portion 554, which has an unknown price.

In particular, the user places the unitary article 550 entirely onto the weighing tray 150 and notes its weight or price by observing a scale display screen 104. If the observed weight or price exceeds the desired weight or price, the user grasps the membrane 500 and slides the unitary article 550 to the left such that a second portion 554 is supported by the shelf 200 and a first portion 552 is supported by the weighing tray 150. The unitary article 550 continues to be moved left until the displayed weight or price reaches the desired weight or price. Alternately, the user may place the unitary article 550 entirely or partially onto the shelf 200 and slide the unitary element to the right until the displayed weight or price reaches the desired weight or price.

The user may then mark the unitary article 550 along a severing line 556 defined by the slot 400. The mark may be made by aligning a knife with the slot 400 and partially severing the unitary article 550 along the severing line 556. The unitary element 550 is then removed from the scale and scale accessory and cut along the severing line 556 to fully sever the unitary article into two portions. Alternately, the unitary article 550 can be fully severed along the severing line 556 without moving the unitary article 550 from its measuring position or the unitary element 550 may be marked and then moved onto the shelf 200 which may also function as a cutting board usable to finish severing the unitary article 550.

Thereafter the unitary element 550 comprises the first portion 552, which has a know weight or price, and the second portion 554 which has an unknown weight or price. Thereafter the process may be repeated by considering the second portion 554 as a new unitary portion 550. Accordingly, the scale accessory 102 is usable to divide a large unitary article into a plurality of smaller portions of equal weight or price, or the scale accessory 102 is usable to divide the large unitary article into a plurality of small portions of non-equal weight as required.

It is noted that errors in measured weight are introduced if the weighing tray 150 and shelf 200 are not coplanar during a weighing cycle. In particular this may occur if the weighing tray 150 or the shelf 200 are vertically deflected by the weight of the article being weighed or the weighing tray 150 or the shelf 200 may be bent or otherwise distorted by the weight of the article being weighed. The amount of scale deflection for a given weight placed on its weighing tray 150 is called the scale compliance and it is desirable that the scale 100 have a low compliance or low vertical deflection over weight range that the scale and scale accessory will be used. Similarly, it is desirable that the shelf 200 and base assembly 102 have sufficient mechanical stiffness to limit the magnitude of shelf vertical deflection, bending and other distortions over the weight range that the scale and scale accessory will be used.

If excess deflection is present, then the unitary article 550 when placed partly on the shelf 200, and partly on tray 150 will cause tray 150 to deflect, thereby causing the tray and shelf to no longer be substantially coplanar. In the case where the article being weighed is a flexible material such as a fish or meat filet, and the tray and shelf are not coplanar, then the article being weighed is kinked, and torque and shear forces are introduced at the bend. These forces cause an error to be introduced in the weight recorded by scale 100. The magnitude of this error depends on the characteristics of the material being weighed and the amount of tray 150 deflection. If the material is nearly rigid, the error can be very large. The magnitude of this error also depends upon how much tray 150 deflects as weight is placed upon it. If the deflection of tray 150 is zero, or close to zero then the torque and shear forces introduced at the kink are small or zero, and relatively stiff materials may be accurately measured. The requirements placed upon scale 100 to minimize this measurement error for a particular class of materials can be calculated.

It is noted that errors in measured weight are introduced if tray 150 and shelf 200 are not coplanar. If placing a weight on shelf 200 or tray 150 causes either to depress but remain parallel, then on offset O_{f} is introduced. This offset causes a kink in the article being weighed.

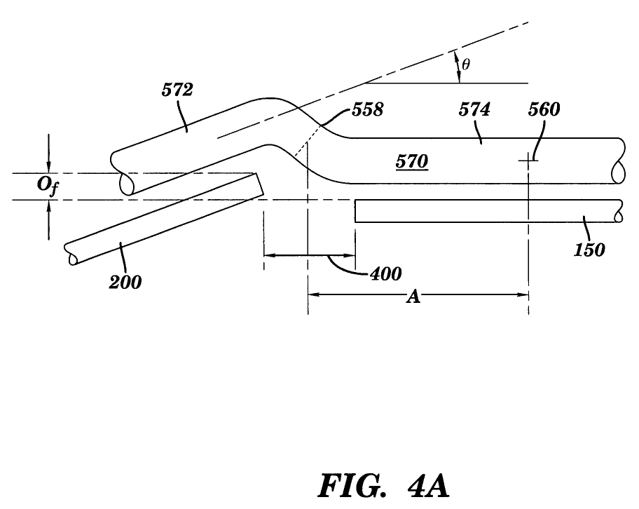

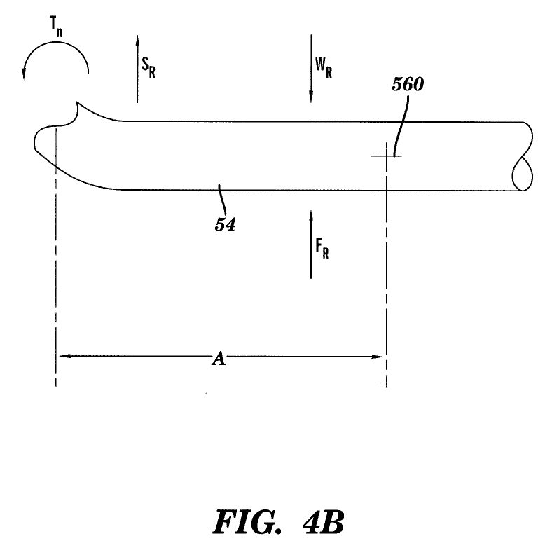

FIG. 4a shows one example of a flexible element 570 supported with a left hand portion 572, resting on shelf 200 and the right hand portion 574 resting on weighing tray 150. The boundary between left portion 572 and right portion 574 is at the center of the gap 400. This boundary is shown as dotted line 558. Left portion 572 is shown displaced from right portion 574 by an amount O_{f} due to shelf 200 and tray 150 not being coplanar. Flexible element 570 also contains a bend specified by angle θ caused by shelf 200 and tray 150 not remaining parallel to each other. This bend could be caused by either shelf 200 or tray 150 sagging, due to a part of the invention not being rigid. For example, if a weight is placed at the left hand edge of shelf 200, it would cause the shelf to sag, thereby inducing a bend in flexible element 570.

FIG. 4b is a force and torque diagram for the right portion 574. It is used to derive the equations to express measurement errors in terms of forces induced by offset O_{f}, and angular deflection θ in fillet 550. All forces and torque's are vector quantities, with positive forces being defined as upward, and positive torque's normal to the plane of the figure and pointing towards the viewer. The arrow on each force or torque denotes directions of the forces and torque's. In this model, left portion 572 and right portion 574 are assumed to be connected only by the forces and torque's listed below;
T_{R} is the torque exerted on the right portion 574, caused by a bend of angle θ in the flexible element 570;
S_{R} is the shear force exerted on the left edge of right portion 574, due to the non zero offset O_{f};
F_{R} is the restoring force exerted by tray 150 of right portion 572. This is the force, expressed as weight, measured by scale 100;
W_{R} is the force exerted by right portion 574 on tray 150 when S_{R} and T_{R} are 0; and,
A is the distance, measured from the center of denoted by line 558 to the center of mass of the right portion 574 on tray 200.

Torque T_{R}, increases from 0, when the bend angle, θ is 0 to a positive number as the bend angle is increase in a clockwise direction. The magnitude of Torque T_{R} also depends upon the coefficient of stiffness of flexible element 570. Shear force S_{R} increases as the amount of offset, O_{f}, increases by lowering tray 150 relative to shelf 200. Torques on right portion 574 must sum to 0. Therefore:

F_{R}−W_{R}+S_{R}+T_{R}/A=0 (1)

Let

WE=the measurement error=F_{R}−W_{R} (2)
Therefore combining equation (2) and (3) yields

WE=−(T_{R}/A+S_{R}) (3)

Let

C=T_{R}/θ (4)
C is proportional to the torsional stiffness of the flexible element 570
Let

S=S_{R}/O_{F} (5)
S is controlled by the stiffness and thickness of the flexible element being weighed. It is not necessarily a constant for all offsets O_{F}
   Equation (3) becomes:

WE=−(C*θ/A+S*O_{f}) (6)
The contribution of T_{R} to measurement error WE was estimated by the following experiment:
   By forcing O_{F} to 0.0, equation (6) becomes

WE=−(C*θ/A)=T_{R}/A (7)

Shelf 200 and tray 150 were adjusted so that they were substantially coplanar. A fresh, raw, fillet of swordfish 570, uncooked and not frozen, with thickness approximately 1.0 inch and total weight approximately 1.0 pounds, was placed partly upon shelf 200 with the remainder supported on tray 150. The position of this fillet was adjusted until the portion of the fillet rested upon tray 150 caused scale 100 to register 0.5 pounds. A weight of 9.0 pounds was then applied to the left hand edge of shelf 200, resulting in an angular deflection, θ of 5 degrees. The right hand edge of shelf 200 was at the same vertical height as the left hand edge of tray 150, thereby causing offset O_{f} to be 0. The measurement error, WE caused by this angular deflection was 0.02 pounds. Assuming that C is linear with angular deflection θ, C/A can be estimated to be 0.004 pounds per degree. In the preferred embodiment, the error in weight, WE caused by C*θ/A is kept to less than 0.02 pounds, or about 2% of a typical one pound right portion 574 of a fillet residing on tray 150. Most of the angular deflection, θ, occurs in shelf 200 as it is supported in this embodiment on its right side only by bracket 310. Assuming that the largest fillet 570 weight is 10 pounds, then left portion 572 weighs 9 pounds, and in the worst case, this weight would be concentrated at the left hand edge of the shelf 200. To maintain two percent error or less under these conditions, then shelf 200, base assembly 300, pin 315 socket 310, and tray 150 must be stiff enough to deflect no more than 5 degrees. By forcing θ to be zero, Equation (6) becomes

WE=−(S*O_{f}) (8)

Shelf 200 and tray 150 were adjusted so that they were substantially coplanar A fresh, raw, fillet of swordfish 570, uncooked and not frozen, with thickness approximately 1.0 inch and total weight approximately 1.0 pounds, was placed partly upon shelf 200 with the remainder supported on tray 150. The position of this fillet 570 was adjusted until the portion of the fillet rested upon tray 150 caused scale 100 to register 0.5 pounds. Without moving fillet 570 shelf 150 was elevated on a plane parallel to shelf 200, but shelf 200 was higher than tray 150 thereby causing offset O_{f} to be 0.3 inches. The weight of the portion of the fillet on tray 150 was recorded. Again without moving the fillet 550 shelf 200 was lowered in 0.1 inch increments. At each increment, the weight of the portion of this fillet on weighing tray 150 was recorded. This process was repeated until the shelf 200 was below tray 150 by 0.3 inches, thus offset O_{F} was −0.3. Positive displacements indicate shelf 200 is higher than tray 150. Negative displacements indicate shelf 200 is lower than tray 150. The results of the experiment are tabulated in Table 1.

TABLE 1

| Offset between Removable Shelf | | |
|---|---|---|
| 200 | | |
| and Weighing Tray 150, in | Measured weight | Measurement Error |
| (Inches) | (Pounds) | (Pounds) |
| O_{f} | F_{R} | WE |
| 0.3 | 0.27 | −0.23 |
| 0.2 | 0.32 | −0.18 |
| 0.1 | 0.39 | −0.11 |
| 0.0 | 0.5 (True Weight) | 0 |
| −0.1 | 0.63 | 0.13 |
| −0.2 | 0.67 | 0.17 |
| 0.3 | 0.71 | 0.21 |

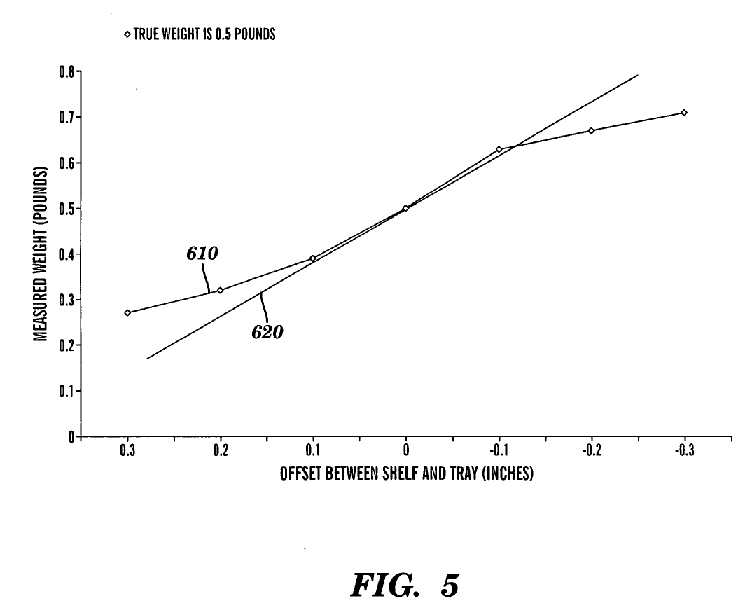

From this process the requirements for how much deflection of weighing tray 150 can be tolerated for a given measurement error can be calculated. FIG. 5, curve 610 is a plot of the measured fillet weight for a given tray deflection. At O_{F}=0 the unwanted shear and torque forces are zero so the measured weight and the true weight are the same, which from table 1 above is 0.5 pounds. From equation (8) it can be seen that S is the slope of the line in FIG. 5, and it varies according to O_{F}. To restrict the error over the entire range of right portion weights, a maximum C should be picked. This is used in equation (8), with the budgeted allowable error to compute a maximum allowable O_{F}. On FIG. 5 a line 620 of maximum slope C is shown, which in this case is 1.25 pounds per inch. To restrict the error in measured weight vs. actual weight, the offset O_{F} must be minimized. It is easy to design shelf 200 that does not increase O_{F} when a weight is placed upon it. However tray 150 must deflect when an object of a given weight is place upon it, as this deflection is what is measured by scale 100 in order to display the weight of the object. The amount of deflection for a given weight placed on tray 150 is the compliance of the scale. Therefore as a practical matter O_{F} is controlled by this compliance. Assume an additional 2% error tolerated due to scale compliance, then from equation (8) where C is 1.25 pounds/inch, then compliance should be less than 0.016 inches per pound.

Thus the reader will see that at least one embodiment of this scale accessory provides a reliable, convenient method to separate a predefined portion of a flexible material from the remainder. While this description contains many specifications, these should not be construed as limitations on the scope of the invention, but rather as exemplification of one preferred embodiment thereof. Many other variations are possible. It is understood that although shelf 200 has been shown on to be positioned on the left hand side of Scale 100, shelf to be on any side of the scale, and may not be removable. It is also understood that the shelf bracket 310 may be permanently attached to Scale 100 thereby eliminating the need for base plate 350, legs 320, and bracket 330. Shelf 200 is shown in the preferred embodiment to be supported on only one side. It is understood that this shelf may be supported on more than one side, thereby greatly increasing its torsional stiffness. Although shelf 200 is shown to be connected to shelf bracket 310 by two pins and sockets, it is understood that this shelf and bracket my be connected by other permanent or non permanent means. Although a programmable scale is shown, it is understood that any scale with an appropriate tray may be used. The requirements for scale compliance were derived based upon a one inch thick fresh swordfish fillet, but the process described may be used to derive this requirement for any flexible material. It is also understood that this invention is not confined to use with food, but may be used in any application where a portion of any flexible material must be separated from the remainder. Accordingly, the scope of the invention should be determined not by the embodiment illustrated, but by the claims and their equivalent.

What is claimed is:

1. An accessory for a scale, wherein the scale includes a bottom support surface opposed to a substantially horizontal top weighing tray configured to weigh a unitary article positioned thereon, comprising:
a shelf supported substantially coplanar with the weighing tray for supporting a first portion of the unitary article on the weighing tray and a second portion of the unitary article on the shelf such that the weighing tray only weighs the first portion of the unitary article;
a base assembly configured to horizontally support the scale bottom support surface thereon and,
a shelf bracket disposed between the base assembly and the shelf for fixedly attaching the shelf to the base assembly.

2. The accessory of claim 1 wherein the weighing tray has a lateral width and a transverse length and the shelf bracket is supported to extend out from the lateral width of the weighing tray and to form a transverse slot between proximate lateral edges of the shelf and the weighing tray such that the slot forms a cutting guide between the shelf and the weighing tray.

3. The accessory of claim 2 wherein the shelf and the shelf bracket are configured to allow the shelf to be hand removed from and hand replaced back onto the shelf bracket.

4. The accessory of claim 3 wherein the base assembly further comprises legs disposed to support the base assembly on a work surface.

5. The accessory of claim 4 wherein each of the elements of the shelf, the shelf bracket and the base assembly comprise food safe materials.

6. The accessory of claim 4 wherein the weighing tray is substantially horizontally disposed at a vertical height above the work surface and the shelf bracket is vertically adjustable with respect to the base assembly for substantially matching a vertical height of the shelf with the vertical height of the weighing tray.

7. The accessory of claim 4 wherein the shelf bracket is rotatably adjustable about a transverse axis with respect to the base assembly such that an angular orientation of the shelf can be adjusted to substantially match the angular orientation of the shelf with the substantially horizontal orientation of the weighing tray.

8. The accessory of claim 4 wherein the base assembly further comprises:
a substantially horizontally disposed base plate forming by a top scale support surface, an opposing bottom base plate surface and lateral and transverse perimeter edges, wherein dimensions of the lateral and transverse perimeter edges are sized to support the bottom surface of the scale on the scale support surface and wherein the legs extend from the base plate to the work surface; and,
a substantially vertically disposed shelf bracket support plate attached to the base plate substantially along an entire transverse perimeter edge thereof with a vertical height of the shelf bracket support plate extending proximate to but below the vertical height of the weighing tray above the work surface.

9. The accessory of claim 8 wherein the shelf bracket comprises a plate disposed between the shelf bracket support plate and the shelf for fixedly attaching to the shelf bracket support plate and the shelf for cantilevering the shelf there from.

10. The accessory of claim 9 wherein the shelf bracket support plate includes a plurality of threaded holes passing there through and positioned to mate with a plurality of vertically oriented slots passing through the shelf bracket and wherein the shelf bracket is fixedly attached to the shelf bracket support plate by threaded fasteners engaged with the threaded holes and wherein the vertically oriented slots provide the vertical adjustment between the shelf bracket and the shelf bracket support plate.

11. The accessory of claim 10 further comprising:
an adjusting screw threaded into a threaded hole passing thorough the shelf bracket and disposed to extend laterally through the shelf bracket vertical support bracket to provide a stop position for stopping a transverse edge of the scale;
a scale securing bracket adjustably attached to the base plate for forcing the scale into contact with the adjusting screw and for clamping the scale in a fixed lateral position on the base plate; and,
wherein the adjusting screw is adjustable to set a desired width of the transverse slot between proximate lateral edges of the shelf and the weighing tray.

12. A method for operating a scale that includes a substantially horizontally disposed weighing tray comprising steps of:
mounted the scale onto a scale accessory that includes a base plate for receiving the scale thereon, a shelf for extending one of a lateral and a transverse dimension of the weighing tray such that a slot extends between opposing edges of the weighing tray and the shelf, and bracket elements disposed between the base plate and the shelf for supporting;
adjusting a position of the scale on the base plate in order to set a width of the slot and securing the scale onto the base plate in the adjusted position;
adjusting the bracket elements to position a vertical height of the shelf to substantially match a vertical height of the weighing tray and securing the bracket elements in the adjusted position;
supporting an article to be weighed with a first portion supported on the weighing tray and a second portion supported on the shelf;
observing the weight of the first portion measured by the scale;
repositioning the article on the shelf and the weighing tray until the first portion supported on the weighing tray weighs a desired amount;
marking the article along a severing line defined by the slot; and,
severing the article along the severing line.

13. The method of claim 12 further comprising the step of disposing a membrane between the article to be weighed and the shelf and weighing tray to facilitate repositioning.

14. The method of claim 13 wherein the scale can be reconfigured to convert weight measurement to a price of an article according to a desired price to unit weight conversion further comprising steps of:
configuring the scale to display a price of the first portion supported on the weighing tray; and,
repositioning the article on the shelf and the weighing tray until the scale indicates that first portion supported on the weighing tray has a desired price.
